(19) United States
(12) Patent Application Publication
(10) Pub. No.: US 2020/0016951 A1
(43) Pub. Date: Jan. 16, 2020

(54) AIR SUSPENSION LEVELING BASED ON DATA AVAILABLE TO THE VEHICLE

(71) Applicant: Continental Automotive Systems, Inc., Auburn Hills, MI (US)

(72) Inventors: Matthew Eric Letizio, Farmington Hills, MI (US); Jason Wray Fegan, Sault Sainte Marie, MI (US); Brian Douglas Wells, Lake Orion, MI (US); Clinton Schumann, Holly, MI (US)

(73) Assignee: Continental Automotive Systems, Inc., Auburn Hills, MI (US)

(21) Appl. No.: 16/031,628

(22) Filed: Jul. 10, 2018

(51) Int. Cl. B60G 17/016; B60G 11/27; B60G 17/052; B60G 99/00

(52) U.S. Cl. CPC B60G 17/016; B60G 11/27; B60G 17/052; B60G 2500/30; B60G 2202/152; B60G 2400/252; B60G 99/008

(57) ABSTRACT

An air suspension system which uses software logic and internal signals and/or external signals available to automatically adjust the ride height of the vehicle. The air suspension system also may respond to requests from other vehicle systems requesting a change in ride height. Signals available to the vehicle may be used to detect parking lot maneuvers (for example, a combination of low speed, high steering angle, and low lateral acceleration) and automatically begin to lower the ride height of the vehicle to a calibrated “entry/exit” ride height. Additionally, a camera, radar, and/or parking sensor signals are utilized to detect potential roof or undercarriage clearance issues, and automatically adjust the ride height of the vehicle. The air suspension system may also adjust the ride height of the vehicle when the electronic brake system (EBS) detects rough road, automatically increasing the ride height of the vehicle to increase ground clearance.

### FIELD OF THE INVENTION

The invention relates generally to an air suspension system having the ability to automatically raise or lower the ride height of the vehicle based on one or more of external signals and internal signals available to the vehicle.

### BACKGROUND OF THE INVENTION

Suspension systems for automotive vehicles provide vehicle passengers with a more comfortable ride. Air suspension systems utilize air springs, rather than traditional coil springs, and provide different suspension qualities that may be preferable to traditional coil spring suspensions in some vehicles.

A conventional air spring is a device that is arranged between a vehicle body and chassis. The typical air spring has at least one working space, or cavity that is filled with compressed air generated by a compressor. The cavity filled with compressed air at least partially fills a bellow, and other surrounding cavities. There are also air suspension systems in which the air pressure is adjustable such that the ride height of the vehicle and the spring rate of each air spring may be adjusted. Some air suspension systems are used with vehicles having off-road capability. These off-road vehicles often operate under conditions where the suspension jounce is maximized, and the pressure in each air spring increases during compression travel. Other instances where it may be beneficial to increase the ride height of the vehicle include traveling up or down steep ramps in a parking garage. There are also situations where it may be beneficial to lower the ride height of the vehicle, such as when the vehicle is entering a parking garage having a low ceiling height, or when the driver or passengers are entering and exiting the vehicle.

Many vehicles include some type of controller or actuator device which may be used by the driver to control the aft suspension system, and therefore control the ride height of the vehicle. However, pushing buttons or adjusting a knob while driving may result in distraction of the driver, and increase the risk of a collision. Furthermore, there may be situations where the driver is unaware that the height of the vehicle may need to be adjusted, such as the ceiling of a parking garage being too low for the vehicle to pass through without the ride height being lowered.

Accordingly, there exists a need for an air suspension system which automatically adjusts the ride height of the vehicle based on input from various devices, without input from the driver of the vehicle.

### SUMMARY OF THE INVENTION

In one embodiment, the present invention is an air suspension system which uses software logic and internal signals and/or external signals available to the vehicle to automatically adjust the ride height of the vehicle. The air suspension system also may respond to requests from other vehicle systems requesting a change in ride height. Examples of these other vehicle systems include, but are not limited to, ADAS, EBS, etc.

In one embodiment, the present invention uses the signals available to the vehicle, such that the air suspension system is able to detect parking lot maneuvers (for example, a combination of low speed, high steering angle, and low lateral acceleration) and automatically begin to lower the ride height of the vehicle to a calibrated “entry/exit” ride height.

In another embodiment, a camera, radar, and/or parking sensor signals are utilized to detect potential roof or undercarriage clearance issues, and automatically adjust the ride height of the vehicle. Examples of this embodiment include, but are not limited to, a vehicle driving into a garage that has low clearance, or a vehicle with low ground clearance going over a speed bump.

In yet another embodiment, the air suspension system adjusts the ride height of the vehicle based on calculated signals, such as when electronic brake system (EBS) detects rough road, the air suspension system automatically increases the ride height of the vehicle to increase ground clearance.

In one embodiment, the present invention is an air suspension system for a vehicle, where the air suspension system includes a control unit, a compressor in electrical communication with the control unit, and a plurality of air spring assemblies. The air suspension system also includes at least one camera in electrical communication with the control unit, at least one radar device in electrical communication with the control unit, and at least one sensor in electrical communication with the control unit. The ride height of the vehicle may be adjusted based on the input, which may correspond to the operation of the vehicle, such as vehicle speed, changes in steering angle, lateral acceleration, and braking.

The ride height of the vehicle may also be adjusted based on feedback from one or more of the camera, radar device, or the sensor. In one configuration, the ride height of the vehicle is decreased to facilitate entry and exit of the vehicle. In another configuration, the ride height of the vehicle is decreased to facilitate avoidance of a collision with the roof of a parking structure. In yet another configuration, the ride height of the vehicle is increased to facilitate avoidance of a collision between the undercarriage of the vehicle and a speed bump.

In one embodiment, the vehicle includes an electronic braking system, and the ride height of the vehicle is adjusted based on input from the electronic braking system. More specifically, in one configuration, the ride height of the vehicle is increased to facilitate the vehicle traversing a rough section of a road, such as a gravel road having rough terrain.

The air suspension system may also be used to lower the ride height of the vehicle based on other commands from the EBS system, such as when the vehicle is performing an extreme maneuver, such as an anti-lock brake system (ABS) event, or when oversteer or understeer has occurred. In this instance, the ride height of the vehicle may be lowered to increase the stability of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of various components of a vehicle used as part of an air suspension system having the ability to automatically raise or lower the ride height of the vehicle, according to embodiments of the present invention;

FIG. 2 is a diagram of an air suspension system having the ability to automatically raise or lower the ride height of the vehicle, according to embodiments of the present invention;

FIG. 3A is a side view of a vehicle travelling through a parking lot at a first ride height, where the vehicle includes an air suspension system having the ability to automatically raise or lower the ride height of the vehicle, according to embodiments of the present invention;

FIG. 3B is a side view of a vehicle located in a parking space of a parking lot, where the vehicle is configured to be at a second ride height, and the vehicle includes an air suspension system having the ability to automatically raise or lower the ride height of the vehicle, according to embodiments of the present invention;

FIG. 4A is a side view of a vehicle entering a parking structure, where the vehicle includes an air suspension system having the ability to automatically raise or lower the ride height of the vehicle, according to embodiments of the present invention;

FIG. 4B is a side view of a vehicle moving towards a speed bump located in a parking structure, where the vehicle includes an air suspension system having the ability to automatically raise or lower the ride height of the vehicle, according to embodiments of the present invention; and

FIG. 5 is a side view of a vehicle moving towards a rough section of road, where the vehicle includes an air suspension system having the ability to automatically raise or lower the ride height of the vehicle, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

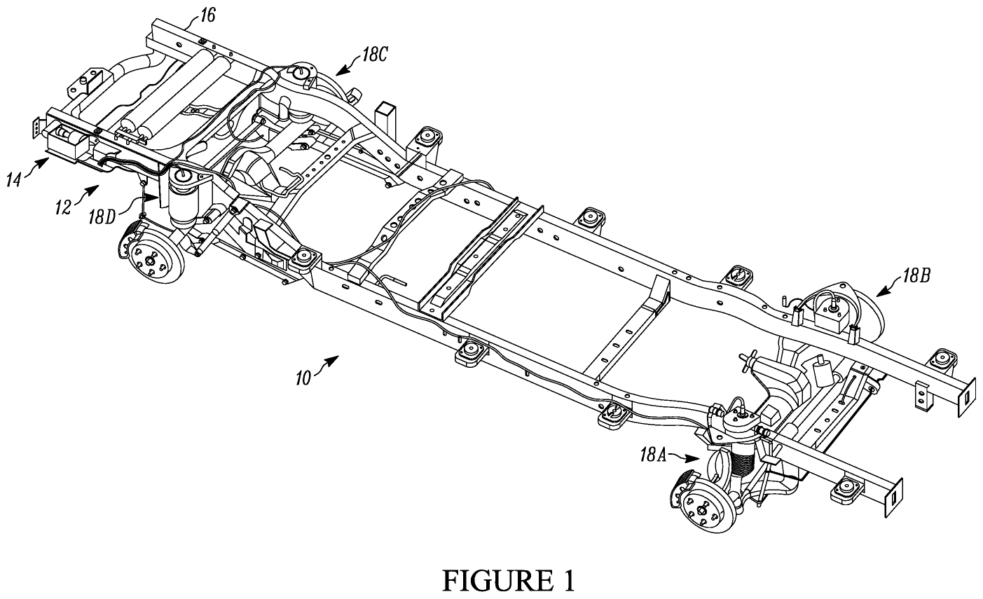

A chassis of a vehicle having an air suspension system according to the present invention is shown in FIG. 1 generally at 10. The air suspension system, shown generally at 12, includes an air compressor 14, which is in fluid communication with a reservoir, shown generally at 16, and the air compressor 14 is also in fluid communication with four air spring assemblies 18A-18D. Each of the air spring assemblies 18A-18D is used for absorbing impact during travel of the vehicle. Each air spring assembly 18A-18D includes similar components, and function in a similar manner.

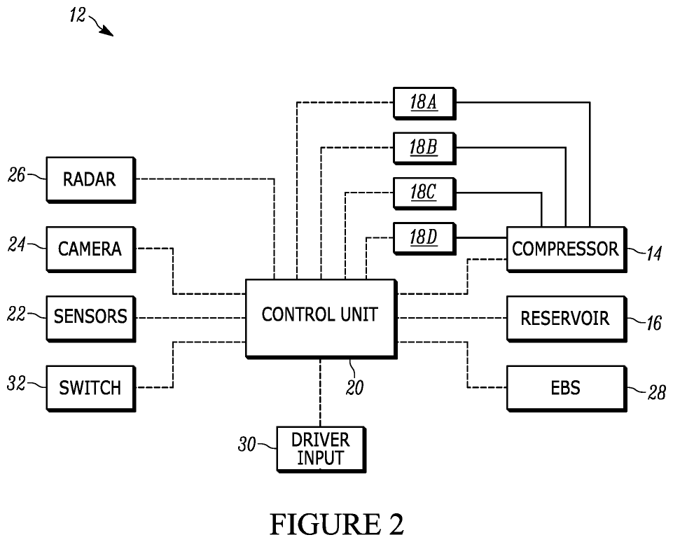

Referring now to FIG. 2, a schematic of the air suspension system 10 having various inputs is shown. The compressor 14 and reservoir 16 are in electrical communication with and controlled by a control unit 18. The control unit 18 is in electrical communication with various detection devices used for detecting various objects, such as speed bumps, curbs, low ceilings, and other objects in the environment around the vehicle. The detection devices may be one or more devices such as sensors 22, cameras 24, radar 26, as well as an electronic braking system (EBS) 28.

The control unit 18 may also receive various input based on how the driver is operating the vehicle, represented at 30. This vehicle operational input 30 may include, but is not limited to, vehicle speed, steering angle, lateral acceleration, and braking. There is also a switch 32 which is in electrical communication with the control unit 18, where the switch may be used by the driver to manually adjust the ride height of the vehicle.

During travel of the vehicle, the air compressor 14 and the air spring assemblies 18A-18D are used to adjust the ride height of the vehicle, to provide the desired ride quality, or adapt to various driving conditions.

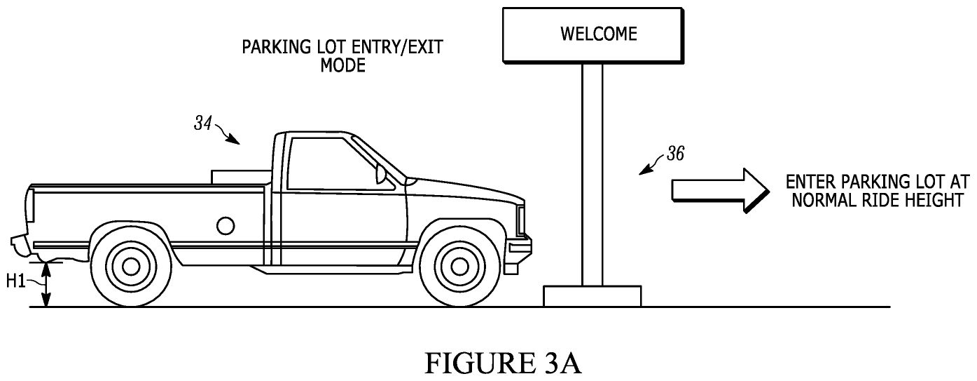

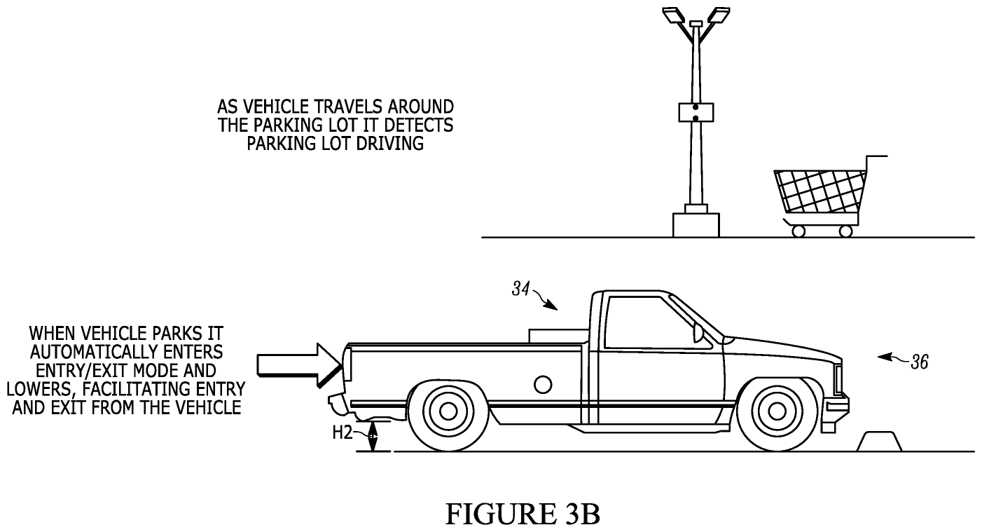

The air suspension system 10 is used to automatically adjust the ride height of the vehicle, without direct driver input (i.e., without the use of the switch 32). One example of this is shown in FIGS. 3A-3B, where a vehicle 34 is shown travelling through a parking lot, shown generally at 36. The vehicle 34 in this example is a truck, which typically have a higher ride height and a higher overall height relative to other types of vehicles, such as a car. As the vehicle 34 enters the parking lot 34, shown in FIG. 3A, the vehicle 34 is traveling at a first ride height H1. However, as the vehicle 34 enters into and maneuvers through the parking lot 36 (i.e., performs one or more parking lot maneuvers), the control unit 18 detects the vehicle operational input 30 that the vehicle speed, changes in steering angle, lateral acceleration, and braking correspond to the vehicle 34 moving slowly, and making sharp turns while the driver is looking for a parking space. The control unit 18 then commands the compressor 14 and the air springs 18A-18D to lower the ride height of the vehicle 34 to a second ride height H2, so when the vehicle 34 stops in a parking space, as shown in FIG. 3B, the height of the vehicle 34 has been lowered to make exiting and entering the vehicle 34 easier.

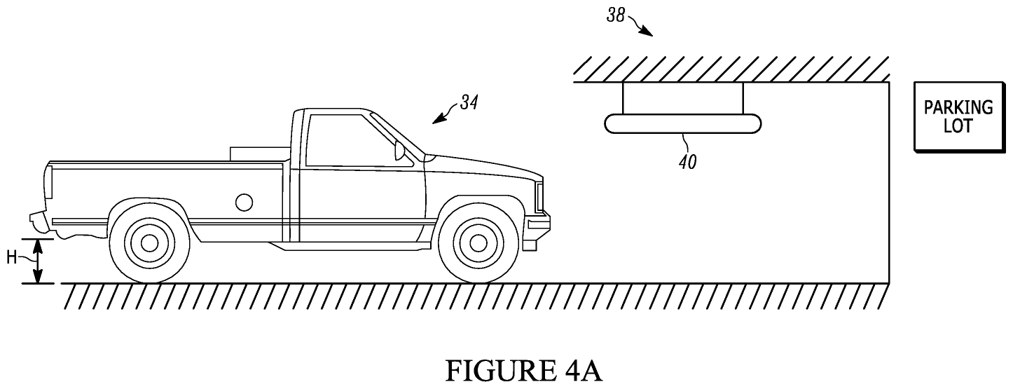

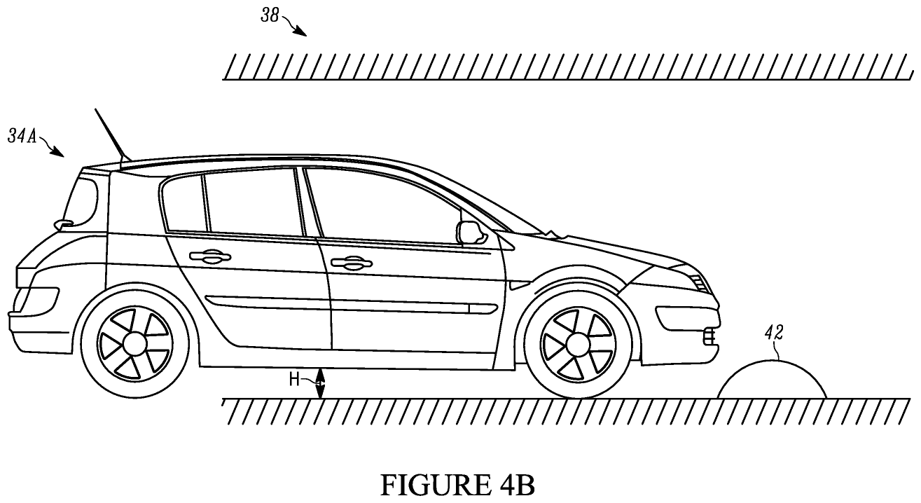

Another example use of the air suspension system 10 of the present invention is shown in FIGS. 4A-4B. The vehicle 34 is entering a parking structure, shown generally at 38, where the parking structure 38 includes a vehicle height bar 40, and the vehicle height bar 40 provides an indication of the maximum allowable height of a vehicle that may enter the structure without risking a collision with the roof of one of the levels of the parking structure 38. The vehicle height bar 40 may be detected by one or more of the sensors 22, camera 24, or radar 26, such that if the ride height H of the vehicle 34 as shown in FIG. 4A would result in the vehicle 34 colliding with the vehicle height bar 40, the control unit 20 configures the compressor 14 and air spring assemblies 18A-18D to lower the ride height H such that the topmost portion of the vehicle is below the vehicle height bar 40.

There may be other situations where the ride height of the vehicle may need to be increased, so as to avoid a collision with a speed bump. Referring to FIG. 4B, another area of the parking structure 38 is shown, which includes a speed bump 42. In the example shown in FIG. 4B, another type of vehicle 34A is shown, which in this example is a car having a generally lower ride height H compared to a truck or an SUV. In FIG. 4B, the speed bump 42 may be detected by one or more of the sensors 22, camera 24, or radar 26, such that if the ride height H of the vehicle 34A as shown in FIG. 4B would result in the vehicle 34A colliding with the speed bump 42, the control unit 20 configures the compressor 14 and air spring assemblies 18A-18D to increase the ride height H such that the vehicle 34A is able to drive over the speed bump 42 at a safe speed without the undercarriage of the vehicle 34A contacting the speed bump 42.

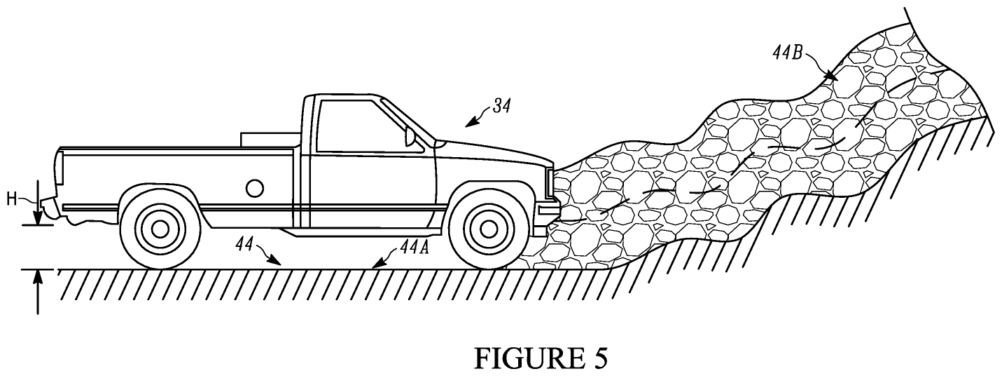

Another example of use of the air suspension system 12 is shown in FIG. 5. In this example, the vehicle 34 is traveling down a road 44, the road 44 has a flat section, shown generally at 44A, made of concrete, and a rough section, shown generally at 44B, which is not concrete, and is generally rough terrain, and on an incline. This change in road type may be detected by the EBS system 28, such that the ride height H of the vehicle 34 shown in FIG. 5 may be increased to provide sufficient ground clearance, and avoid damage to the undercarriage of the vehicle 34 when the vehicle 34 is traversing the rough section 44B of the road 44.

The air suspension system 12 may also be used to lower the ride height H of the vehicle 34 based on other commands from the EBS system 28, such as when the vehicle 34 is performing an extreme maneuver, such as an anti-lock brake system (ABS) event, or when oversteer or understeer has occurred. In this instance, the ride height H of the vehicle 34 may be lowered to increase the stability of the vehicle 34.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an air suspension system for a vehicle, including:
a control unit;
a compressor in electrical communication with the control unit;
a plurality of air spring assemblies in electrical communication with the control unit, and the plurality of air spring assemblies in fluid communication with the compressor; and
at least one detection device operable for detecting one or more objects in the environment around the vehicle;
wherein the control unit commands the compressor and the plurality of air spring assemblies to configure the ride height of the vehicle independently of driver input, and based on feedback from the at least one detection device.

2. The apparatus of claim 1, further comprising at least one input, wherein the control unit commands the compressor and the plurality of air spring assemblies to adjust the ride height of the vehicle based on the at least one input.

3. The apparatus of claim 2, the at least one input further comprising one or more selected from the group consisting of vehicle speed, changes in steering angle, lateral acceleration, and braking.

4. The apparatus of claim 1, wherein the ride height of the vehicle is decreased after the vehicle performs at least one parking lot maneuver.

5. The apparatus of claim 1, the vehicle further comprising:
a first ride height; and
a second ride height, the second ride height being lower than the first ride height;
wherein the vehicle is reconfigured from the first ride height to the second ride height.

6. The apparatus of claim 1, the at least one detection device further comprising:
at least one camera in electrical communication with the control unit;
at least one radar device in electrical communication with the control unit; and
at least one sensor in electrical communication with the control unit;
wherein the control unit commands the compressor and the plurality of air spring assemblies to adjust the ride height of the vehicle based on input from at least one of the at least one camera, the at least one radar device, or the at least one sensor.

7. The apparatus of claim 6, wherein the ride height of the vehicle is decreased to facilitate entry and exit of the vehicle.

8. The apparatus of claim 6, wherein the ride height of the vehicle is decreased to facilitate avoidance of a collision with the roof of a parking structure.

9. The apparatus of claim 6, wherein the ride height of the vehicle is increased to facilitate avoidance of a collision between the undercarriage of the vehicle and a speed bump.

10. The apparatus of claim 6, wherein the ride height of the vehicle is decreased to increase the stability of the vehicle when an understeer event has occurred, or an oversteer event has occurred.

11. The apparatus of claim 1, further comprising an electronic braking system, wherein the ride height of the vehicle is adjusted based on input from the electronic braking system.

12. The apparatus of claim 10, wherein the ride height of the vehicle is increased to facilitate the vehicle traversing a rough section of a road.

13. An air suspension system for a vehicle, comprising:
a control unit;
a compressor in electrical communication with the control unit;
a plurality of air spring assemblies, each of the plurality of air spring assembly in fluid communication with the compressor, each of the plurality of air spring assembly in electrical communication with the control unit, the control unit operable for controlling the compressor and the plurality of air spring assemblies to adjust the ride height of the vehicle;
at least one camera in electrical communication with the control unit;
at least one radar device in electrical communication with the control unit;
at least one sensor in electrical communication with the control unit;
at least one input;
wherein during a first mode of operation, the ride height of the vehicle is adjusted based on the at least one input, and during a second mode of operation, the ride height of the vehicle is adjusted based on one or more of the at least one of the at least one camera, the at least one radar device, or the at least one sensor.

14. The air suspension system of claim 13, the at least one input further comprising one or more selected from the group consisting of vehicle speed, changes in steering angle, lateral acceleration, and braking.

15. The air suspension system of claim 13, wherein the ride height of the vehicle is decreased to facilitate entry and exit of the vehicle.

16. The air suspension system of claim 15, wherein the ride height of the vehicle is decreased to facilitate avoidance of a collision with the roof of a parking structure.

17. The air suspension system of claim 13, wherein the ride height of the vehicle is increased to facilitate avoidance of a collision between the undercarriage of the vehicle and a speed bump.

18. The air suspension system of claim 13, further comprising an electronic braking system, wherein the ride height of the vehicle is adjusted based on input from the electronic braking system.

19. The air suspension system of claim 18, wherein the ride height of the vehicle is increased to facilitate the vehicle traversing a rough section of a road.

20. The air suspension system of claim 13, wherein the ride height of the vehicle is decreased to increase the stability of the vehicle when an understeer event has occurred, or an oversteer event has occurred.
